(19) United States
(12) Patent Application Publication
(10) Pub. No.: US 2022/0415097 A1
(43) Pub. Date: Dec. 29, 2022

(54) VEHICLE-MOUNTED RELAY APPARATUS, PROGRAM, AND REPLY METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-shi, Osaka (JP)

(72) Inventor: Yuichi KODAMA, Yokkaichi-shi, Mie (JP)

(21) Appl. No.: 17/756,469

(22) PCT Filed: Nov. 12, 2020
(86) PCT No.: PCT/JP2020/042281

§ 371 Date: May 25, 2022

(30) Foreign Application Priority Data
Nov. 28, 2019 (JP) 2019-215677

(51) Int. Cl. G07C 5/00; G06F 8/65; B60L 53/62

(52) U.S. Cl. CPC G07C 5/008; G06F 8/65; B60L 53/62

(57) ABSTRACT

A vehicle-mounted relay apparatus includes a control unit that controls relay of messages, whereby the control unit, when relaying an update program obtained from an external server to a vehicle-mounted ECU to be updated, relays the update program in a plurality of relay modes to be updated, the plurality of relay modes includes a first relay mode in which relay of a message between vehicle-mounted ECUs other than the vehicle-mounted ECU to be updated is prohibited and a second relay mode in which relay of a message between vehicle-mounted ECUs other than the vehicle-mounted ECU to be updated and a vehicle-mounted ECU related to a charge control apparatus is prohibited, and the control unit selects the first relay mode or the second relay mode based on a predetermined condition.

### CROSS-REFERENCE TO RELATED APPLICATIONS

This application is the U.S. national stage of PCT/JP2020/042281 filed on Nov. 12, 2020, which claims priority of Japanese Patent Application No. JP 2019-215677 filed on Nov. 28, 2019, the contents of which are incorporated herein.

### TECHNICAL FIELD

The present disclosure relates to a vehicle-mounted relay apparatus, a program, and a relay method.

### BACKGROUND

ECUs (Electronic Control Units) for controlling vehicle-mounted devices such as powertrain devices for engine control and the like and body devices for air-conditioner control and the like are mounted in a vehicle. Each ECU includes a computational processing unit such as an MPU, a rewritable non-volatile storage unit such as a RAM, and a communication unit for communicating with other ECUs, and performs control of a vehicle-mounted device by loading and executing a control program stored in the storage unit. Furthermore, a communication device that has a wireless communication function is implemented in the vehicle, and it is possible to communicate, via the communication device, with a program providing apparatus connected to a network outside the vehicle, download (receive) a control program of an ECU from the program providing apparatus, and update the control program of the ECU (for example, see JP 2017-97851A).

There is a problem with a relay apparatus in JP 2017-97851A in that the influence on a vehicle-mounted ECU (charge ECU) that is responsible for charge control, when a control program is updated while a vehicle is being charged, is not taken into consideration.

### SUMMARY

An object of the present disclosure is to provide a vehicle-mounted relay apparatus and the like capable of performing appropriate processing for updating a control program even when a vehicle is being charged.

A vehicle-mounted relay apparatus according to an aspect of the present disclosure is a vehicle-mounted relay apparatus that is to be mounted in a vehicle that includes a charge control apparatus, includes a plurality of in-vehicle communication units that are to be connected to a communication line for communicating with a plurality of vehicle-mounted ECUs, and relays, between the in-vehicle communication units, a message that is transmitted from the plurality of vehicle-mounted ECUs, the vehicle-mounted relay apparatus including: a control unit configured to control relay of the message, whereby the control unit, when relaying an update program obtained from an external server outside the vehicle to a vehicle-mounted ECU to be updated, relays the update program or the message in a plurality of relay modes, the plurality of relay modes include a first relay mode in which relay of a message between vehicle-mounted ECUs other than the vehicle-mounted ECU to be updated is prohibited and a second relay mode in which relay of a message between vehicle-mounted ECUs other than the vehicle-mounted ECU to be updated and a vehicle-mounted ECU related to the charge control apparatus is prohibited, and the control unit selects the first relay mode or the second relay mode based on a predetermined condition.

### Effects of the Present Disclosure

According to an aspect of the present disclosure, it is possible to provide a vehicle-mounted relay apparatus and the like for performing appropriate processing for updating a control program even when a vehicle is being charged.

### BRIEF DESCRIPTION OF DRAWINGS

FIG. 1 is a schematic diagram illustrating a configuration of a vehicle-mounted relay system that includes a vehicle-mounted relay apparatus according to a first embodiment.

FIG. 2 is a block diagram illustrating a physical configuration of the vehicle-mounted relay apparatus.

FIG. 3 is an explanatory diagram illustrating one aspect of configuration information of vehicle-mounted ECUs.

FIG. 4 is a flowchart illustrating processing that is performed by a control unit of the vehicle-mounted relay apparatus.

FIG. 5 is a flowchart illustrating processing that is performed by a control unit of a vehicle-mounted relay apparatus according to a second embodiment.

FIG. 6 is a schematic diagram illustrating a configuration of a vehicle-mounted relay system that includes a vehicle-mounted relay apparatus according to a third embodiment.

FIG. 7 is a flowchart illustrating processing that is performed by a control unit of the vehicle-mounted relay apparatus according to the third embodiment.

### DETAILED DESCRIPTION OF PREFERRED EMBODIMENTS

First, aspects of the present disclosure will be enumerated and described below. At least some of the aspects described below may be combined as appropriate.

### First Aspect

A vehicle-mounted relay apparatus according to a first aspect of the present disclosure is a vehicle-mounted relay apparatus that is to be mounted in a vehicle that includes a charge control apparatus, includes a plurality of in-vehicle communication units that are to be connected to a communication line for communicating with a plurality of vehicle-mounted ECUs, and relays, between the in-vehicle communication units, a message that is transmitted from the plurality of vehicle-mounted ECUs, the vehicle-mounted relay apparatus including: a control unit configured to control relay of the message, whereby the control unit, when relaying an update program obtained from an external server outside the vehicle to a vehicle-mounted ECU to be updated, relays the update program or the message in a plurality of relay modes, the plurality of relay modes include a first relay mode in which relay of a message between vehicle-mounted ECUs other than the vehicle-mounted ECU to be updated is prohibited and a second relay mode in which relay of a message between vehicle-mounted ECUs other than the vehicle-mounted ECU to be updated and a vehicle-mounted ECU related to the charge control apparatus is prohibited, and the control unit selects the first relay mode or the second relay mode based on a predetermined condition.

In the first aspect, when an update program obtained from an external server outside the vehicle is output (relayed) to the vehicle-mounted ECU to be updated, the vehicle-mounted relay apparatus relays the new program or the message in a plurality of relay modes that include a first relay mode and a second relay mode. In the first relay mode, relay of a message between vehicle-mounted ECUs other than the vehicle-mounted ECU to be updated is prohibited, and thus the update program or the like obtained from the external server can be efficiently relayed (output) to the vehicle-mounted ECU to be updated without performing unnecessary relay. In the second relay mode, relay of a message between vehicle-mounted ECUs other than the vehicle-mounted ECU to be updated and a vehicle-mounted ECU related to the charge control apparatus is prohibited, and thus, for example, even when the vehicle is being charged by the charge control apparatus, it is possible to continue relay of a message to the vehicle-mounted ECU related to the charge control apparatus, and continue charging. The vehicle-mounted relay apparatus selects the first relay mode or the second relay mode based on a predetermined condition, and thus it is possible to efficiently relay (output) the update program or the like obtained from an external server to the vehicle-mounted ECU to be updated, in an appropriate relay mode in accordance with the state of the vehicle.

### Second Aspect

In the vehicle-mounted relay apparatus according to a second aspect of the present disclosure, the predetermined condition includes a condition related to charging of the vehicle, and the control unit selects the first relay mode when the vehicle is not being charged, and selects the second relay mode when the vehicle is being charged.

In the second aspect, the vehicle-mounted relay apparatus selects the first relay mode or the second relay mode in accordance with a state of charging of the vehicle that is performed by the charge control apparatus, in other words whether or not charging is being executed. When the vehicle is not being charged by the charge control apparatus, the vehicle-mounted relay apparatus selects the first relay mode. Since relay of a message of the vehicle-mounted ECU related to the charge control apparatus is not necessary when the vehicle is not being charged, the vehicle-mounted relay apparatus selects the first relay mode when charging is not being executed, and thus the update program or the like obtained from the external server can be efficiently relayed (output) to the vehicle-mounted ECU to be updated without unnecessary relay being performed. When charging is being executed, the second relay mode is selected, and thus it is possible to relay the update program while continuing charging.

### Third Aspect

In the vehicle-mounted relay apparatus according to a third aspect of the present disclosure, the predetermined condition includes a condition related to a connection form between vehicle-mounted ECUs related to the charge control apparatus and the in-vehicle communication units, the connection form includes a first connection form in which the vehicle-mounted ECUs related to the charge control apparatus are connected to the same in-vehicle communication unit and a second connection form in which the vehicle-mounted ECUs related to the charge control apparatus are respectively connected to different in-vehicle communication units, and the control unit selects the first relay mode when the connection form is the first connection form, and selects the second relay mode when the connection form is the second connection form.

In the third aspect, the connection form between vehicle-mounted ECUs related to the charge control apparatus and the in-vehicle communication units includes the first connection form in which the vehicle-mounted ECUs related to the charge control apparatus are connected to the same in-vehicle communication unit and the second connection form in which the vehicle-mounted ECUs related to the charge control apparatus are respectively connected to different in-vehicle communication units. In the first connection form in which the vehicle-mounted ECUs related to the charge control apparatus are connected to the same in-vehicle communication unit, one or more vehicle-mounted ECUs related to the charge control apparatus perform communication therebetween, without communicating via the vehicle-mounted relay apparatus, in other words, without communication being relayed by the vehicle-mounted relay apparatus, and it is possible for the charge control apparatus to continue charging the vehicle. Therefore, in a case of the first connection form, the control unit can efficiently relay (output) an update program or the like obtained from an external server to the vehicle-mounted ECU to be updated without performing unnecessary relay, by selecting the first relay mode. In the second connection form in which the vehicle-mounted ECUs related to the charge control apparatus are respectively connected to different in-vehicle communication units, there is a need to perform communication between the vehicle-mounted ECUs related to the charge control apparatus, in order for the charge control apparatus to continue charging the vehicle. In view of this, in a case of the second connection form, by selecting the second relay mode, the control unit can continue relay of a message of the vehicle-mounted ECU related to the charge control apparatus and efficiently relay (output) to the vehicle-mounted ECU to be updated, an update program or the like obtained from an external server while continuing charging performed by the charge control apparatus.

### Fourth Aspect

In the vehicle-mounted relay apparatus according to a fourth aspect of the present disclosure, messages that are transmitted from the plurality of vehicle-mounted ECUs include a CAN message that uses a CAN protocol, and the control unit specifies a message from a vehicle-mounted ECU related to the charge control apparatus based on an identifier included in the CAN message transmitted from the plurality of vehicle-mounted ECUs.

In a fourth aspect, the vehicle-mounted relay apparatus specifies a message from the vehicle-mounted ECU related to the charge control apparatus based on the identifier (CAN-ID) included in the CAN (Controller Area Network) message, and thus can efficiently specify a message from a vehicle-mounted ECU related to the charge control apparatus in a vehicle-mounted LAN in which the CAN protocol is used.

### Fifth Aspect

In the vehicle-mounted relay apparatus according to a fifth aspect of the present disclosure, messages that are transmitted from the plurality of vehicle-mounted ECUs include an IP packet that uses an Ethernet protocol, and the control unit specifies a message from a vehicle-mounted ECU related to the charge control apparatus based on a transmission source address or a transmission destination address included in the IP packet that is transmitted from the plurality of vehicle-mounted ECUs.

In the fifth aspect, the vehicle-mounted relay apparatus specifies a message from the vehicle-mounted ECU related to the charge control apparatus based on the transmission source address or the transmission destination address included in the IP packet, and thus can efficiently specify a message from a vehicle-mounted ECU related to the charge control apparatus, in a vehicle-mounted LAN in which the Ethernet protocol is used.

### Sixth Aspect

A program according to a sixth aspect of the present disclosure causes a computer to execute processing for obtaining an update program from an external server outside a vehicle, selecting a first relay mode in which relay of a message between vehicle-mounted ECUs other than a vehicle-mounted ECU to be updated is prohibited or a second relay mode in which relay of a message between vehicle-mounted ECUs other than the vehicle-mounted ECU to be updated and a vehicle-mounted ECU related to a charge control apparatus is prohibited, based on a predetermined condition, and relaying the update program or a message in the selected relay mode.

In the sixth aspect, it is possible to cause a computer to function as a vehicle-mounted relay apparatus.

### Seventh Aspect

A relay method according to a seventh aspect of the present disclosure causes a computer to execute processing for obtaining an update program from an external server outside a vehicle, selecting a first relay mode in which relay of a message between vehicle-mounted ECUs other than a vehicle-mounted ECU to be updated is prohibited or a second relay mode in which relay of a message between vehicle-mounted ECUs other than the vehicle-mounted ECU to be updated and a vehicle-mounted ECU related to a charge control apparatus is prohibited, based on a predetermined condition, and relaying the update program or a message in the selected relay mode.

In the seventh aspect, it is possible to provide a relay method for performing appropriate processing for updating a control program even when the vehicle is being charged.

The present disclosure will be described in detail with reference to the drawings illustrating embodiments thereof. A vehicle-mounted relay apparatus 2 according to an embodiment of the present disclosure will be described below with reference to the drawings. The present disclosure is not limited to illustrations of these, but is indicated by the claims, and all changes that come within the meaning and range of equivalency of the claims are intended to be embraced therein.

### First Embodiment

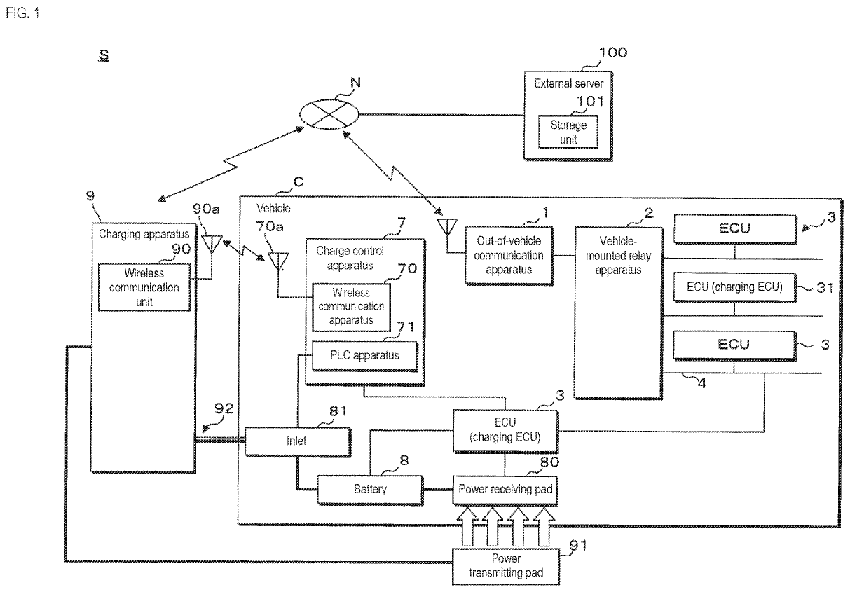

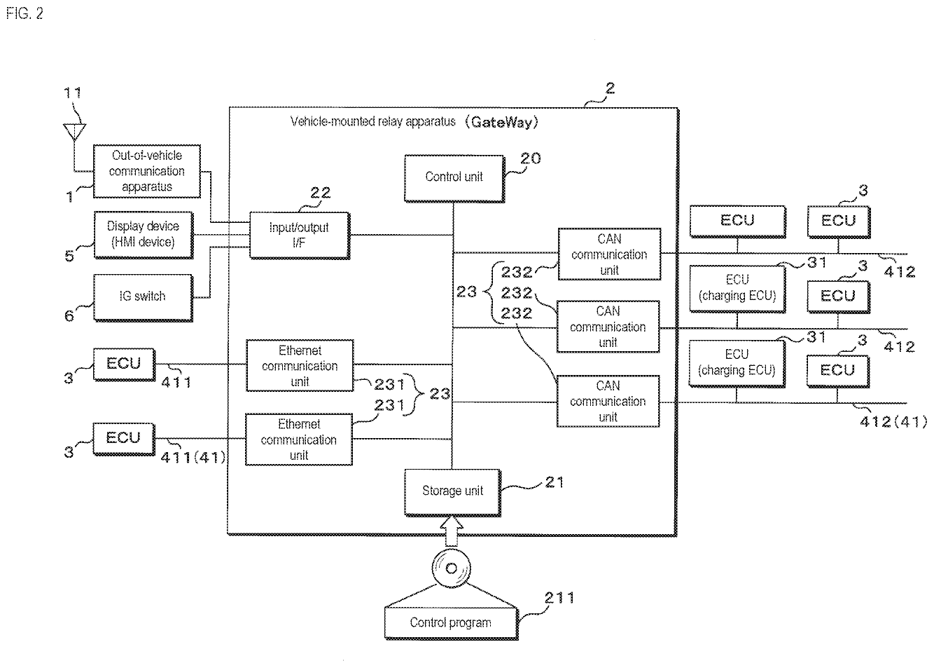

Embodiments will be described below with reference to the drawings. FIG. 1 is a schematic diagram showing a configuration of a vehicle-mounted relay system according to a first embodiment. FIG. 2 is a block diagram showing a configuration of a vehicle-mounted relay apparatus 2 and the like. A vehicle-mounted relay system S includes an out-of-vehicle communication apparatus 1 mounted in a vehicle C and the vehicle-mounted relay apparatus 2, and transmits (relays) a program or data obtained from an external server 100 connected via an out-of-vehicle network N to a vehicle-mounted ECU 3 (Electronic Control Unit/vehicle-mounted control apparatus) mounted in the vehicle C.

The external server 100 is, for example, a computer such as a server connected to an out-of-vehicle network N such as the Internet or a public network, includes a storage unit 101 that is constituted by a RAM (Random Access Memory), a ROM (Read Only Memory), a hard disk, and the like, and corresponds to a program providing apparatus. A program or data for controlling the vehicle-mounted ECU 3 created by the manufacturer of the vehicle-mounted ECU 3 or the like is recorded in the storage unit 101 of the external server 100. The program or data is transmitted as an update program to the vehicle C as will be described below, and is used for updating the program or data of the vehicle-mounted ECU 3 mounted in the vehicle C. The external server 100 configured in this manner is also referred to as an “OTA (Over The Air) server”. The vehicle-mounted ECU 3 that is mounted in the vehicle can update (reprogram) a program that is to be executed by the ECU itself, by obtaining an update program transmitted from the external server 100 through wireless communication, and applying the update program as a program to be executed.

Hereinafter, a program will be described as a program that includes a program code that includes a control syntax for the vehicle-mounted ECU 3 to perform processing and the like, and an external file in which data that is referred to for executing the program code is written. When an update program is transmitted, the program code and the external file in which data is written are transmitted from the external server 100 as an encrypted archive file, for example.

The out-of-vehicle communication apparatus 1, the vehicle-mounted relay apparatus 2, a display device 5, and a plurality of vehicle-mounted ECUs 3 for controlling various vehicle-mounted devices are mounted in the vehicle C. Furthermore, a charge control apparatus that is communicably connected to a charging apparatus provided outside the vehicle and performs control for charging a battery 8 that is mounted in the vehicle C using power output from the charging apparatus, a charging ECU 31 and an inlet 81 that are communicably connected to the charge control apparatus, and a power receiving pad 80 are mounted in the vehicle C. The out-of-vehicle communication apparatus 1 and the vehicle-mounted relay apparatus 2 are communicably connected by a harness such as a serial cable. The vehicle-mounted relay apparatus 2 and the vehicle-mounted ECUs 3 are communicably connected by an in-vehicle LAN 4 that complies with a communication protocol of CAN (Control Area Network/registered trademark), Ethernet (registered trademark), or the like.

A charging apparatus 9 is an apparatus that transmits power to the vehicle C that is a plug-in hybrid automobile, an electrical automobile, or the like in which the battery 8 for driving a vehicle is mounted, and charges the battery 8. The charging apparatus 9 is installed outside the vehicle C, for example, in a power supply station. The charging apparatus 9 includes a power transmitting pad 91 for supplying (transmitting) power to the vehicle C in a non-contact manner. The power receiving pad 80 for receiving power transmitted from the power transmitting pad 91 is provided in the vehicle C. The battery 8 is charged with power received by the power receiving pad 80. Accordingly, the vehicle C is charged. The charging apparatus 9 includes a wireless communication unit 90 that performs wireless communication using a communication protocol of Wi-Fi (registered trademark), Bluetooth (registered trademark), or the like. The wireless communication unit 90 communicates with (transmits/receives data to/from) a later-described charge control apparatus 7 mounted in the vehicle C, via an antenna 90a connected thereto.

The charging apparatus 9 further includes a power supply wire (charge cable) 92 that has a charging gun provided on a leading end portion thereof, and has a function of supplying power to the vehicle C via the power supply wire 92 as a DC current and charging the battery 8. When charging is performed via the power supply wire 92, the charging gun is connected to the inlet 81 provided in the vehicle C. The inlet 81 is connected to the battery 8 by an in-vehicle power supply wire, and is connected to PLC (Power Line Communication) apparatus 71 included in the charge control apparatus 7 to be described below, using a communication line 41 for performing PLC. The battery 8 is charged with power supplied from the charging apparatus 9 via the power supply wire 92, the inlet 81, and the in-vehicle power supply wire. The charging apparatus 9 can perform wired communication with the charge control apparatus 7 through power line communication that uses the power supply wire 92. The charging apparatus 9 is configured to be capable of both non-contact power supply (power supply using the power transmitting pad 91) and power supply using the power supply wire 92, but may also be configured to be capable of only one of the two types of power supply. When the charging apparatus 9 only performs power supply using the power supply wire 92, for example, the wireless communication unit 90 does not need to be included. The charging apparatus 9 may include a communication apparatus (not illustrated) and be communicable with the external server 100. Communication between the charging apparatus 9 and the external server 100 may be performed via the out-of-vehicle network N, for example.

The charge control apparatus 7 includes a wireless communication apparatus 70 and the PLC apparatus 71. The wireless communication apparatus 70 is a communication apparatus for performing wireless communication using a communication protocol of Wi-Fi, Bluetooth, or the like. The wireless communication apparatus 70 performs wireless communication with the charging apparatus 9 via an antenna 70a connected thereto. The wireless communication apparatus 70 performs protocol conversion from Wi-Fi to CAN or Ethernet, for example. If the charging gun is connected to the inlet 81, the PLC apparatus 71 performs power line communication with the charging apparatus 9 via the inlet 81 and the power supply wire 92. The PLC apparatus 71 performs protocol conversion from the communication protocol of power line communication to CAN or Ethernet, for example. The charge control apparatus 7 communicates with the charging apparatus 9 through wireless communication performed by the wireless communication apparatus 70. In addition, the charge control apparatus 7 communicates with the charging apparatus 9 through power line communication that is performed by the PLC apparatus 71. In this embodiment, the wireless communication apparatus 70 and the PLC apparatus 71 are incorporated in the charge control apparatus 7 as constituent elements of the charge control apparatus 7, but do not need to be incorporated in the charge control apparatus 7. A configuration may be adopted in which, for example, the wireless communication apparatus 70 and the PLC apparatus 71 are separate from the charge control apparatus 7, and are communicably connected to the charge control apparatus 7 by an input/output I/F or the like.

The charge control apparatus 7 is communicably connected to the charging ECU 31 (vehicle-mounted ECU 3 related to the charge control apparatus), which is a vehicle-mounted ECU 3 from among a plurality of vehicle-mounted ECUs 3. The charging ECU 31 is a vehicle-mounted ECU 3 related to charging, and is connected to the battery 8 and the power receiving pad 80, for example. When charging of the battery 8 is started, for example, the charging ECU 31 transmits information regarding the battery 8 to the charge control apparatus 7, and, when the battery 8 is being charged, the charging ECU 31 monitors (manages) charge information such as the charging rate of the battery 8, and transmits the charge information to the charge control apparatus 7. Also, the charging ECU 31 monitors (manages) power supply (charge) from the power receiving pad 80 to the battery 8. The charge control apparatus 7 performs wireless communication or power line communication with the charging apparatus 9, and controls charging of the battery 8 (charging of the vehicle C) in cooperation with the charging ECU 31. The charge control apparatus 7 performs power line communication with the charging apparatus 9 via the power supply wire 92 in the case of power supply (charge) that uses the power supply wire 92, and performs wireless communication with the charging apparatus 9 using the wireless communication apparatus 70 in the case of non-contact power supply (charge), for example. Even in the case of power supply that uses the power supply wire 92, the charge control apparatus 7 may perform wireless communication with the charging apparatus 9 using the wireless communication apparatus 70. A plurality of charging ECUs 31 may be mounted in the vehicle C. A charging ECU 31 for managing the battery 8 and a charging ECU 31 for managing the power receiving pad 80 may be connected to the charge control apparatus 7, for example.

A single charging ECU 31 or a plurality of charging ECUs 31 may be mounted in the vehicle C. If a plurality of charging ECUs 31 are mounted in the vehicle C, each of these charging ECUs 31 may be, for example, communicably connected to the charge control apparatus 7, the battery 8, and an electrical storage apparatus for an auxiliary device (not illustrated), or a power related vehicle-mounted apparatus or device such as an alternator (not illustrated), and perform a series of charge-related processing in cooperation. These charging ECUs 31 correspond to vehicle-mounted ECUs related to the charge control apparatus. A configuration may be adopted in which a charging ECU 31 from among the plurality of charging ECUs 31 is incorporated in the charge control apparatus 7, and the charge control apparatus 7 is connected to a vehicle-mounted network.

In this embodiment, these charging ECUs 31 are connected to different communication lines 41 (buses), and communication between these charging ECUs 31 is performed via a vehicle-mounted relay apparatus, that is to say, a message transmitted/received between a plurality of charging ECUs 31 is relayed by the vehicle-mounted relay apparatus.

The charge control apparatus 7 is communicably connected to the vehicle-mounted relay apparatus 2 via one of the charging ECUs 31. In this embodiment, the charge control apparatus 7 communicates with the vehicle-mounted relay apparatus 2 via the charging ECU 31 and the in-vehicle LAN 4. The vehicle-mounted relay apparatus 2 and the charge control apparatus 7 may be connected, for example, by the in-vehicle LAN 4, and perform communication. After charging of the battery 8 is complete, the charge control apparatus 7 transmits a charge complete notification to the vehicle-mounted relay apparatus 2. The charge control apparatus 7 obtains information regarding the charge state by performing communication with the charging apparatus 9 or in accordance with a supply-of-power (power supply) state from the power receiving pad 80 and the inlet 81, and outputs the information to the vehicle-mounted relay apparatus 2.

The vehicle-mounted relay apparatus 2 can obtain information regarding the charge state of the vehicle C in which the vehicle-mounted relay apparatus 2 is mounted, by communicating with the charge control apparatus 7. The information regarding the charge state of the vehicle C includes whether or not the vehicle C is being charged, charge progress, and the remaining capacity of the battery 8 (SOC: State of Charge) that is to be charged, for example.

The vehicle-mounted relay apparatus 2 includes a control unit 20, a storage unit 21, and an in-vehicle communication unit 23. The vehicle-mounted relay apparatus 2 is configured to obtain, from the out-of-vehicle communication apparatus 1, an update program received from the external server 100 by the out-of-vehicle communication apparatus 1 through wireless communication, and transmit the update program to a predetermined vehicle-mounted ECU 3 (a vehicle-mounted ECU 3 to be updated) via the in-vehicle LAN 4.

The vehicle-mounted relay apparatus 2 is a gateway (relay device) that performs overall control of a plurality of types of buses (segments) of a vehicle-mounted body ECU 3, a vehicle-mounted safety ECU 3, a vehicle-mounted control ECU 3, and the like, and relays communication between vehicle-mounted ECUs 3 using these buses (segments). That is to say, the vehicle-mounted relay apparatus 2 functions as a CAN gateway in relay that uses a CAN protocol, and functions as a layer 2 switch or a layer 3 switch in relay that uses the TCP/IP protocol. Alternatively, the vehicle-mounted relay apparatus 2 may be configured as one function unit of the body ECU that controls the entire vehicle C.

In a state where update processing for, for example, transmitting an update program received from the external server 100 to the vehicle-mounted ECU 3 to be updated is not being performed, the vehicle-mounted relay apparatus 2 performs relay of communication between vehicle-mounted ECUs 3 connected to the vehicle-mounted relay apparatus 2. Relay that is performed in a state where update processing for, for example, transmitting an update program received from the external server 100 to the vehicle-mounted ECU 3 to be updated is not being performed is referred to as a “normal relay mode”. When update processing for, for example, transmitting an update program received from the external server 100 to the vehicle-mounted ECU 3 to be updated is performed, the vehicle-mounted relay apparatus 2 performs relay processing in a relay mode that is different from the above-described normal relay mode (a first relay mode or a second relay mode). This will be described later in detail.

The control unit 20 is constituted by a CPU (Central Processing Unit), an MPU (Micro Processing Unit), and the like, and performs various types of control processing, computational processing, and the like by reading out and executing a control program and data stored in the storage unit 21 in advance.

The storage unit 21 is constituted by a volatile memory device such as a RAM (Random Access Memory) or a non-volatile memory device such as a ROM (Read Only Memory), an EEPROM (Electrically Erasable Programmable ROM), or a flash memory, and stores, in advance, a control program and data that is referred to at the time of processing. The control program stored in the storage unit 21 may be a control program read out from a recording medium 211 that can be read by the vehicle-mounted relay apparatus 2, and then stored. The control program stored in the storage unit 21 may also be a control program downloaded from an external computer (not illustrated) connected to a communication network (not illustrated), and stored in the storage unit 21. Furthermore, the storage unit 21 stores configuration information of all of the vehicle-mounted ECUs 3 that are mounted in the vehicle C. The storage unit 21 stores an update program obtained from the external server 100 or information regarding progress when an update program is transmitted to the vehicle-mounted ECU 3.

The storage unit 21 stores relay path information (a routing table) that is used when performing relay processing for communication between vehicle-mounted ECUs 3 or communication between a vehicle-mounted ECU 3 and the external server 100. The format of the relay path information is determined based on a communication protocol. When the communication protocol is the CAN communication protocol, the relay path information for CAN includes a message identifier (CAN-ID) included in a CAN message and a relay destination associated with the CAN-ID (a I/O port number of a CAN communication unit 232). When the communication protocol is the TCP/IP communication protocol, relay path information for TCP/IP includes a transmission destination address (MAC address or IP address) included in an IP packet and a relay destination (physical port number of an Ethernet communication unit 231) associated with the transmission destination address.

Similarly to the input/output I/F of the out-of-vehicle communication apparatus 1, an input/output I/F 22 is a communication interface for performing serial communication, for example. The vehicle-mounted relay apparatus 2 is communicably connected to the out-of-vehicle communication apparatus 1, the display device 5 (HMI device), and an IG switch 6 for starting and stopping the vehicle C, via the input/output I/F 22.

The in-vehicle communication unit 23 includes, for example, an input/output interface (a CAN communication unit 232, an Ethernet communication unit 231) that uses a communication protocol of CAN (Control Area Network), CAN-FD (CAN with Flexible Data Rate), or Ethernet (Ethernet/registered trademark), and functions as a communication unit for the vehicle-mounted relay apparatus 2 and vehicle-mounted ECUs 3 to perform communication. The in-vehicle communication unit 23 includes the CAN communication unit 232 and the Ethernet communication unit 231.

The CAN communication unit 232 complies with the CAN or CAN-FD communication protocol, and supports CAN messages that are transmitted on a CAN bus 412. The CAN communication unit 232 is a CAN transceiver or a CAN-FD transceiver that receives a waveform formed by the potential difference in the differential voltage on the CAN bus 412 constituted by two wires, namely the wire on the high side and wire on the low side, and decodes the received waveform into a signal represented by a bit string of 1s and 0s. Alternatively, the CAN communication unit 232 may include a CAN transceiver and a CAN controller, or a CAN-FD transceiver and a CAN-FD controller.

The Ethernet communication unit 231 is an Ethernet PHY unit that supports TCP/IP packets that are transmitted on an Ethernet cable 411 of 100BASE-T1, 1000BASE-T1, or the like.

A plurality of in-vehicle communication units 23 (the Ethernet communication unit 231, the CAN communication unit 232) are provided, and communication lines 41 (the Ethernet cable 411, the CAN bus 412), in other words, buses that constitute a vehicle-mounted network 4, are respectively connected to the in-vehicle communication units 23. A configuration may be adopted in which, by providing a plurality of in-vehicle communication units 23 in this manner, the vehicle-mounted network 4 is divided into a plurality of buses (segments), and the vehicle-mounted ECUs 3 are respectively connected to the segments according to the functions of the vehicle-mounted ECUs 3. The control unit 20 of the vehicle-mounted relay apparatus 2 mutually communicates with vehicle-mounted ECUs 3 connected to the vehicle-mounted network 4 via in-vehicle communication units 23 or a vehicle-mounted device such as another relay apparatus.

Similarly to the vehicle-mounted relay apparatus 2, each vehicle-mounted ECU 3 includes a control unit (not illustrated), a storage unit (not illustrated) and an in-vehicle communication unit (not illustrated). The storage unit is constituted by a volatile memory element such as a RAM (Random Access Memory) or a non-volatile memory element such as a ROM (Read Only Memory), an EEPROM (Electrically Erasable Programmable ROM), or a flash memory, and stores a program or data of the vehicle-mounted ECU 3. This program or data is transmitted from a program providing apparatus, and is updated to an update program that is relayed by the vehicle-mounted relay apparatus 2. Similarly to the vehicle-mounted relay apparatus 2, the in-vehicle communication unit of the vehicle-mounted ECU 3 includes an Ethernet communication unit or a CAN communication unit, and the vehicle-mounted ECU 3 communicates with the vehicle-mounted relay apparatus 2 via the in-vehicle communication unit. Vehicle-mounted ECUs 3 that are connected to different communication lines 41 (buses) perform communication via the vehicle-mounted relay apparatus 2. That is to say, a message that is transmitted/received between vehicle-mounted ECUs 3 connected to different communication lines 41 (buses) is relayed by the vehicle-mounted relay apparatus 2. As described above, the vehicle-mounted ECUs 3 include the charging ECU 31.

The display device 5 is an HMI (Human Machine Interface) apparatus such as the display of a car navigation. The display device 5 is communicably connected to the input/output I/F 22 of the vehicle-mounted relay apparatus 2 by a harness such as a serial cable. Data or information output from the control unit 20 of the vehicle-mounted relay apparatus 2 via the input/output I/F 22 is displayed on the display device 5.

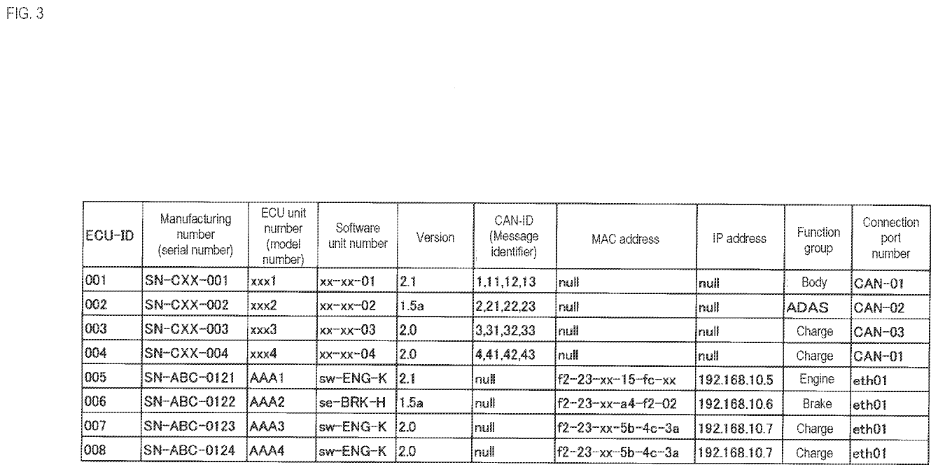

FIG. 3 is an explanatory diagram illustrating one aspect of configuration information of vehicle-mounted ECUs 3. As described above, the configuration information of the vehicle-mounted ECUs 3 is stored in the storage unit 21 of the vehicle-mounted relay apparatus 2. Alternatively, the configuration information of the vehicle-mounted ECUs 3 may be stored in the storage unit of one of the vehicle-mounted ECUs 3 that are mounted in the vehicle C or in a predetermined storage region that can be accessed by the vehicle-mounted relay apparatus 2 (the control unit 20), such as the storage unit 101 of the external server 100.

The configuration information of each vehicle-mounted ECU 3 (a vehicle C configuration information master table) includes, as management items (fields), the manufacturing number (serial number), the ECU unit number (model number), the software unit number, the version, the CAN-ID (CAN message identifier), the MAC (Media Access Control) address, the IP address, the function group, the connection port number, and the like of the vehicle-mounted ECU 3, and is managed in association with an ECU-ID that is formed of a sequential number or the like set not to be duplicated with the other vehicle-mounted ECUs 3.

The manufacturing number (serial number) is a number provided when the vehicle-mounted ECU 3 was manufactured, and is constituted by a lot number indicating the production base or the like, a sequential number at the time of manufacturing, and the like, and is a unique number that enables the ECU to be uniquely specified. The ECU unit number (model number) is a number for specifying the type of the vehicle-mounted ECU 3, and is a component number, for example. The software unit number is a number for specifying a type of software of an update program. The version refers to the version number of a program that is currently executed (applied) by the vehicle-mounted ECU 3, and is the version number of a program stored on the operation surface of the storage unit 21 of the vehicle-mounted ECU 3.

If the in-vehicle communication unit 23 of the vehicle-mounted ECU 3 is a communication port that complies with the CAN protocol (the CAN communication unit 232), the CAN-ID is a CAN message identifier that is used in a CAN message that is transmitted by the vehicle-mounted ECU 3.

If the in-vehicle communication unit 23 of the vehicle-mounted ECU 3 is a communication port that complies with the Ethernet standard (the Ethernet communication unit 231), the MAC address is an address corresponding to a data link layer. The MAC address is a number provided when the in-vehicle communication unit 23 was manufactured, and is a unique number that is constituted by a vendor code indicating the manufacturer, a sequential number at the time of manufacturing, and the like, and that enables the ECU to be uniquely specified. If the in-vehicle communication unit 23 is a communication port that complies with the Ethernet standard, the IP address is an address corresponding to a network layer when communication that uses TCP/IP is performed.

The function group is information regarding the function classification of the vehicle-mounted ECU 3, and the function classification includes, for example, a body-related function, an ADAS-related function, and a charge-related function.

The connection port number is the port number of the in-vehicle communication unit 23 of the vehicle-mounted relay apparatus 2 compatible with the communication line 41 (bus) that is connected to the vehicle-mounted ECU 3. That is to say, the vehicle-mounted relay apparatus 2 and the vehicle-mounted ECU 3 are directly connected by the communication line 41 (bus) connected to the connection port number stored in the “connection port number” field. When the vehicle-mounted ECU 3 performs communication using the CAN protocol, the connection port number of the vehicle-mounted ECU 3 indicates the I/O port number of the CAN communication unit 232. If the vehicle-mounted ECU 3 performs communication using the Ethernet protocol, the connection port number of the vehicle-mounted ECU 3 indicates the physical port number of the Ethernet communication unit 231.

The control unit 20 of the vehicle-mounted relay apparatus 2 can specify which vehicle-mounted ECU 3 from among a plurality of vehicle-mounted ECUs 3 that are mounted in the vehicle C is the charging ECU 31, by referring to the configuration information of the vehicle-mounted ECUs 3 stored in the storage unit 21 (the vehicle C configuration information master table). The vehicle-mounted relay apparatus 2 may be configured to, when specifying which vehicle-mounted ECU 3 is the charging ECU 31, specify the vehicle-mounted ECU 3 for which the content stored in the “function group” field indicates a charge-related function (charge), as the charging ECU 31, for example. Alternatively, the vehicle-mounted relay apparatus 2 may be configured to specify the vehicle-mounted ECU 3 for which a value stored in the “CAN-ID” field is a number related to a charge-type message, as the charging ECU 31, for example. Alternatively, the vehicle-mounted relay apparatus 2 may determine whether or not a vehicle-mounted ECU 3 is the charging ECU 31 based on the ECU unit number or the software unit number.

The configuration information of the vehicle-mounted ECUs 3 that are mounted in the vehicle C is stored and held in the storage unit 21 of the vehicle-mounted relay apparatus 2, for example, when the vehicle C is manufactured. Furthermore, for example, when the IG switch 6 is switched on or switched off, or at a predetermined timing, the control unit 20 of the vehicle-mounted relay apparatus 2 may steadily or periodically request all of the vehicle-mounted ECUs 3 mounted in the vehicle C or a specific vehicle-mounted ECU 3 to transmit configuration information thereof and the update histories of the configuration information. The vehicle-mounted relay apparatus 2 may then obtain and aggregate configuration information or update histories transmitted from the vehicle-mounted ECUs 3, store the aggregated configuration information and the like in the storage unit 21, and update the vehicle C configuration information master table. In this manner, even if an additional vehicle-mounted ECU 3 or a vehicle-mounted apparatus such as a vehicle-mounted device is mounted in the vehicle C after the vehicle C is manufactured, the vehicle-mounted relay apparatus 2 can obtain and be aware of the most recent configuration information of the vehicle C by steadily or periodically aggregating the configuration information of the vehicle-mounted ECUs 3.

The control unit 20 of the vehicle-mounted relay apparatus 2 is configured to relay an update program obtained from the external server 100 outside the vehicle and a message that is transmitted/received between vehicle-mounted ECUs 3 in a plurality of relay modes by executing a control program stored in the storage unit 21. The plurality of relay modes include a normal relay mode that is performed in a case where update processing for, for example, transmitting an update program received from the external server 100 to the vehicle-mounted ECU 3 to be updated is not being carried out, and a first relay mode and a second relay mode that are selected in a case where update processing for, for example, transmitting an update program to the vehicle-mounted ECU 3 to be updated is carried out.

As described above, the normal relay mode is a relay mode that is performed by the control unit 20 of the vehicle-mounted relay apparatus 2 in a state where update processing for, for example, transmitting an update program to the vehicle-mounted ECU 3 to be updated is not being carried out, and the control unit 20 relays a message (CAN message, IP packet) that is transmitted from the vehicle-mounted ECU 3, based on the relay path information (routing table) stored in the storage unit 21, for example.

The control unit 20 of the vehicle-mounted relay apparatus 2 selects the first relay mode or the second relay mode in accordance with a predetermined condition. The predetermined condition is, for example, a condition that is based on information regarding the charge state of the vehicle C, and includes a condition on whether or not the vehicle C is supplied with power from a charging apparatus and the battery 8 mounted in the vehicle C is being charged. The control unit 20 of the vehicle-mounted relay apparatus 2 obtains information regarding the charge state of the vehicle C by communicating with the charge control apparatus 7. When the battery 8 mounted in the vehicle C is not being charged, the control unit 20 of the vehicle-mounted relay apparatus 2 selects the first relay mode. When the battery 8 mounted in the vehicle C is being charged, the control unit 20 of the vehicle-mounted relay apparatus 2 selects the second relay mode.

The first relay mode is a relay mode in which an update program is output from the in-vehicle communication unit 23 connected to the vehicle-mounted ECU 3 to be updated, and relay of a message between vehicle-mounted ECUs 3 other than the vehicle-mounted ECU 3 to be updated is prohibited. In the first relay mode, the control unit 20 of the vehicle-mounted relay apparatus 2 does not perform relay to the in-vehicle communication units 23 other than the in-vehicle communication unit 23 connected to the vehicle-mounted ECU 3 to be updated, and outputs an update program obtained from the out-of-vehicle communication apparatus 1, from the in-vehicle communication unit 23 that is connected to the vehicle-mounted ECU 3 to be updated.

The control unit 20 of the vehicle-mounted relay apparatus 2 specifies a vehicle-mounted ECU 3 to be updated and an in-vehicle communication unit 23 (connection port number) that is connected to the vehicle-mounted ECU 3, based on an update program obtained from the external server 100 or information accompanying the update program, for example, by referring to the vehicle C configuration information master table. Alternatively, the control unit 20 of the vehicle-mounted relay apparatus 2 may specify a message identifier transmitted by the vehicle-mounted ECU 3 to be updated, by referring to the vehicle C configuration information master table, and prohibit relay of a message that includes a message identifier other than the message identifier of the specified vehicle-mounted ECU 3 to be updated.

The control unit 20 of the vehicle-mounted relay apparatus 2 relays an update program obtained from the external server 100 to the vehicle-mounted ECU 3 to be updated, by outputting the update program from the specified in-vehicle communication unit 23 (connection port number). When outputting the update program from the specified in-vehicle communication unit 23 (connection port number), or carrying out update processing that includes preprocessing and postprocessing that are performed before and after the outputting, the control unit 20 of the vehicle-mounted relay apparatus 2 prohibits relay to an in-vehicle communication unit 23 other than the specified in-vehicle communication unit 23. When a series of update processing is related to a plurality of vehicle-mounted ECUs 3, in other words, when there are a plurality of vehicle-mounted ECUs 3 that are to be updated, the control unit 20 of the vehicle-mounted relay apparatus 2 may prohibit relay to an in-vehicle communication unit 23 other than the plurality of in-vehicle communication units 23 that are respectively connected to these plurality of vehicle-mounted ECUs 3 that are to be updated.

By performing relay processing in the first relay mode, relay of a message between vehicle-mounted ECUs 3 other than the vehicle-mounted ECU 3 to be updated is prohibited, and thus it is possible to efficiently relay (output) an update program obtained from the external server 100 to the vehicle-mounted ECU 3 to be updated without performing unnecessary relay.

The second relay mode is a relay mode in which an update program is output from the in-vehicle communication unit 23 that is connected to the vehicle-mounted ECU 3 to be updated, and relay of a message between a vehicle-mounted ECU 3 other than the vehicle-mounted ECU 3 to be updated and the charging ECU 31 (the vehicle-mounted ECU 3 related to the charge control apparatus 7) is prohibited. Similarly to the first relay mode, in the second relay mode, the control unit 20 of the vehicle-mounted relay apparatus 2 relays an update program obtained from the external server 100 to the vehicle-mounted ECU 3 to be updated, and performs only relay of a message that is transmitted/received between charging ECUs 31.

The control unit 20 of the vehicle-mounted relay apparatus 2 specifies a message identifier (CAN-ID) that is to be used by the charging ECU 31 with reference to the vehicle C configuration information master table, for example, and relays a CAN message in which the message identifier is included in the header thereof. Alternatively, the control unit 20 of the vehicle-mounted relay apparatus 2, for example, refers to the vehicle C configuration information master table, specifies the IP address of the charging ECU 31, and relays an IP packet in which the IP address is included in the header thereof as a transmission source address or a transmission destination address. Also, the control unit 20 of the vehicle-mounted relay apparatus 2 prohibits relay of an update program and a message other than a message of the charging ECU 31.

By performing relay processing in the second relay mode, relay of a message between vehicle-mounted ECUs 3 other than the vehicle-mounted ECU 3 to be updated and the charging ECU 31 (the vehicle-mounted ECU 3 related to the charge control apparatus 7) is prohibited, and thus even when the vehicle C (the battery 8) is being charged, it is possible to continue relay of a message to the charging ECU 31, and to continue charging.

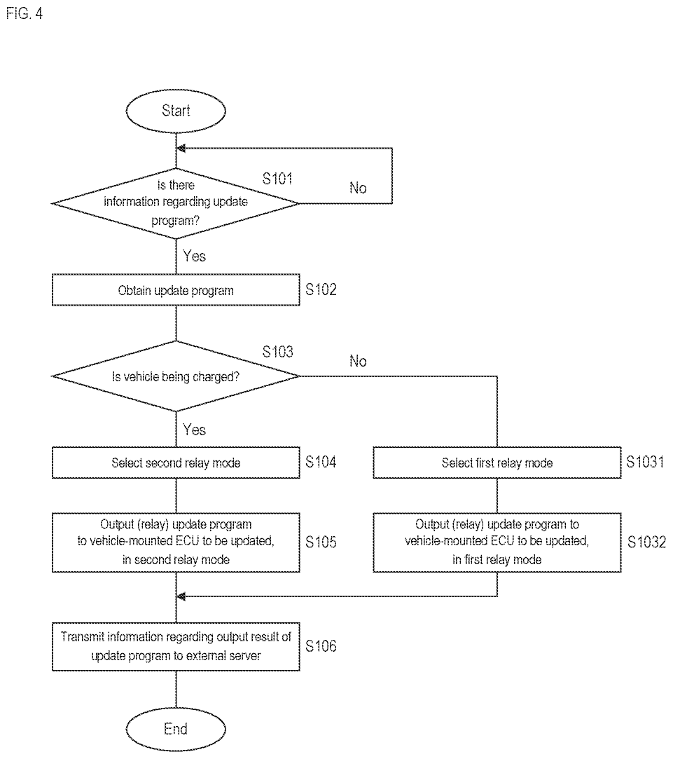

FIG. 4 is a flowchart illustrating processing that is performed by the control unit 20 of the vehicle-mounted relay apparatus 2. The control unit 20 of the vehicle-mounted relay apparatus 2 steadily performs the following processing, when the vehicle C is operating (the IG switch 6 is on) or is stopped (the IG switch 6 is off), for example.

The control unit 20 of the vehicle-mounted relay apparatus 2 determines whether or not there is information regarding an update program (step S101). The control unit 20 communicates with the external server 100 via the out-of-vehicle communication apparatus 1, inquires about whether or not there is information regarding an update program, and determines whether or not there is information regarding the update program such as campaign information. The determination on whether or not there is information regarding an update program may be performed based not only on pull communication for an inquiry from the vehicle-mounted relay apparatus 2 to the external server 100, but also on push communication for a message or the like that is transmitted from the external server 100 to the vehicle-mounted relay apparatus 2.

If there is no information regarding an update program (step S101: NO), the control unit 20 of the vehicle-mounted relay apparatus 2 performs loop processing in order to execute the processing of step S101 again. By performing the loop processing, the control unit 20 of the vehicle-mounted relay apparatus 2 periodically inquires of the external server 100 about whether or not there is information regarding an update program. When there is no information regarding an update program in this manner, the control unit 20 performs relay processing in the above normal relay mode.

When there is information regarding an update program (step S101: YES), the control unit 20 of the vehicle-mounted relay apparatus 2 obtains the update program (step S102). The control unit 20 obtains the update program from the external server 100 via the out-of-vehicle communication apparatus 1.

The control unit 20 of the vehicle-mounted relay apparatus 2 determines whether or not the vehicle C is being charged (step S103). The control unit 20 obtains information regarding the charge state of the vehicle C by communicating with the charge control apparatus 7, and determines whether or not the vehicle C is being charged.

When the vehicle C is not being charged (step S103: NO), the control unit 20 of the vehicle-mounted relay apparatus 2 selects the first relay mode (step S1031). In the first relay mode, the control unit 20 of the vehicle-mounted relay apparatus 2 outputs (relays) the update program to the vehicle-mounted ECU 3 to be updated. The control unit 20 selects the first relay mode, outputs the update program from the in-vehicle communication unit 23 that is connected to the vehicle-mounted ECU 3 to be updated, and prohibits relay of a message between vehicle-mounted ECUs 3 other than the vehicle-mounted ECU 3 to be updated.

If the vehicle C is being charged (step S103: YES), the control unit 20 of the vehicle-mounted relay apparatus 2 selects the second relay mode (step S104). In the second relay mode, the control unit 20 of the vehicle-mounted relay apparatus 2 outputs (relays) the update program to the vehicle-mounted ECU 3 to be updated (step S105). The control unit 20 selects the second relay mode, outputs the update program from the in-vehicle communication unit 23 that is connected to the vehicle-mounted ECU 3 to be updated, and prohibits relay of a message between a vehicle-mounted ECU 3 other than the vehicle-mounted ECU 3 to be updated and the charging ECU 31 (the vehicle-mounted ECU 3 related to the charge control apparatus 7).

The control unit 20 of the vehicle-mounted relay apparatus 2 transmits information regarding the output result of the update program to the external server 100 (step S106). The control unit 20 transmits (outputs) the information regarding the output result of the update program, such as the time and date when the update program was transmitted to the vehicle-mounted ECU 3 to be updated, a response result received as a transmission result from the vehicle-mounted ECU 3 to be updated, or information indicating that update processing was carried out normally to the external server 100 via the out-of-vehicle communication apparatus 1. The control unit 20 may output the information regarding the output result of the update program to the display device 5. By outputting the information regarding the output result of the update program to the external server 100 or the display device 5, it is possible to notify the information to the manager of the external server 100 or the operator of the vehicle C.

According to this embodiment, the vehicle-mounted relay apparatus 2 obtains information regarding the charge state of the vehicle C from the charge control apparatus 7, and selects the first relay mode or the second relay mode in accordance with the information regarding the charge state of the vehicle C, in other words whether or not charging is being executed (whether or not the vehicle C is being charged). When charging of the vehicle C is not being executed (the vehicle C is not being charged), there is no need to relay a message to the charging ECU 31, and thus the vehicle-mounted relay apparatus 2 can efficiently relay (output) the update program and the like obtained from the external server 100 to the vehicle-mounted ECU 3 to be updated, without performing unnecessary relay by selecting the first relay mode. When charging of the vehicle C is being executed (the vehicle C is being charged), the vehicle-mounted relay apparatus 2 relays only a message that is transmitted/received by the charging ECU 31 together with the update program, and thus can continue charging.

### Second Embodiment

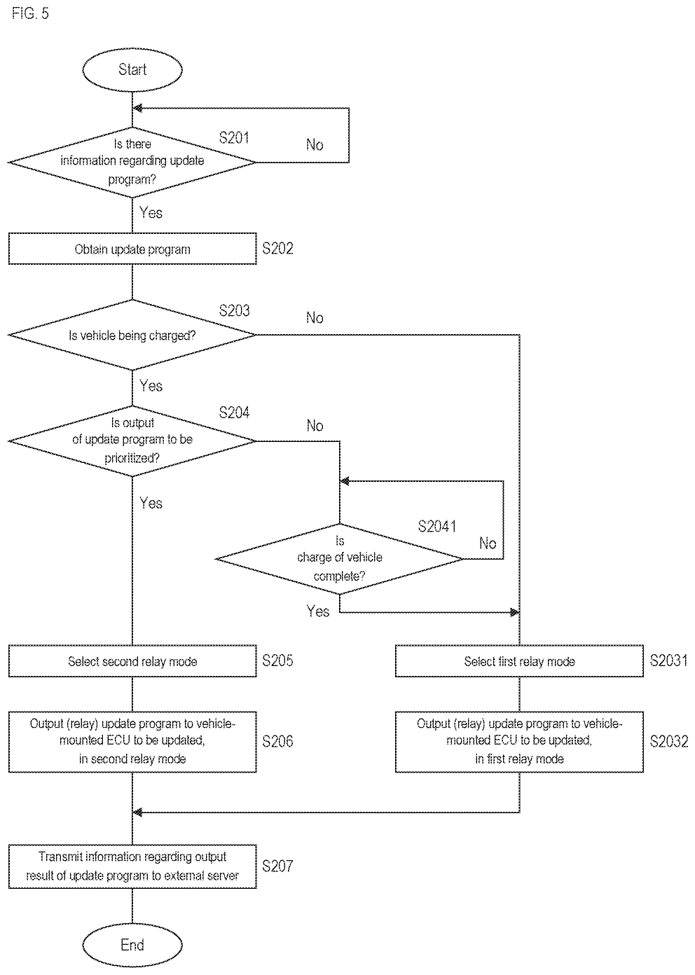

FIG. 5 is a flowchart illustrating processing that is performed by the control unit 20 of the vehicle-mounted relay apparatus 2 according to a second embodiment. The control unit 20 of the vehicle-mounted relay apparatus 2 steadily performs the following processing, for example, when the vehicle C is in an operating state (the IG switch 6 is on) or stopped state (the IG switch 6 is off). The control unit 20 of the vehicle-mounted relay apparatus 2 performs processing of steps S201 to S203 similarly to the processing of steps S101 to S103 in the first embodiment.

The control unit 20 of the vehicle-mounted relay apparatus 2 determines whether or not to prioritize output of the update program (step S204). The control unit 20 determines whether or not to prioritize output of the update program over charging based on the state of the vehicle C such as the remaining capacity of the battery 8 (SOC). The control unit 20 may determine that output of the update program is to be prioritized over charging (step S204: YES), for example, when the remaining capacity (SOC) is higher than a predetermined threshold value of 70% or the like. That is to say, if the remaining capacity (SOC) is lower than or equal to the predetermined threshold value of 70% or the like, it is determined that the battery capacity is not sufficient for performing update processing such as output of the update program, and it may be determined not to prioritize output of the update program over charging (step S204: NO), in other words it may be determined to prioritize charging over output of the update program.

If output of the update program is not prioritized (step S204: NO), the control unit 20 of the vehicle-mounted relay apparatus 2 determines whether or not charging of the vehicle C is complete (step S2041). The control unit 20 obtains information that includes whether or not charging of the vehicle C is complete, by communicating with the charge control apparatus 7, and determines whether or not charging of the vehicle C is complete, based on this information.

If charging of the vehicle C is not complete (step S2041: NO), the control unit 20 of the vehicle-mounted relay apparatus 2 performs loop processing, in order to perform the processing of S2041 again. By performing the loop processing, the control unit 20 performs standby processing until charging of the vehicle C is complete.

When charging of the vehicle C is complete (step S2041: YES), the control unit 20 of the vehicle-mounted relay apparatus 2 selects the first relay mode (step S2031). The control unit 20 performs the processing of steps S2031 and S2032 similarly to the processing of/in steps S1031 and S1032 in the first embodiment.

If output of the update program is prioritized (step S204: YES), the control unit 20 of the vehicle-mounted relay apparatus 2 selects the second relay mode (step S205). The control unit 20 of the vehicle-mounted relay apparatus 2 performs the processing of steps S205 to S207 similarly to the processing of steps S104 to S106 in the first embodiment.

According to this embodiment, the vehicle-mounted relay apparatus 2 determines whether or not to prioritize output of the update program over charging, for example, in accordance with the remaining capacity of the battery 8 (SOC) or the like, and relays the update program to the vehicle-mounted ECU 3 to be updated, in the first relay mode or the second relay mode. Therefore, it is possible to relay the update program to the vehicle-mounted ECU 3 to be updated, in a suitable relay mode that is based on the state of the vehicle C such as the remaining capacity of the battery 8 (SOC), and to prevent relay processing of the update program from being abnormally terminated due to power that is output from the battery 8 becoming deficient while the relay processing of the update program is being performed.

### Third Embodiment

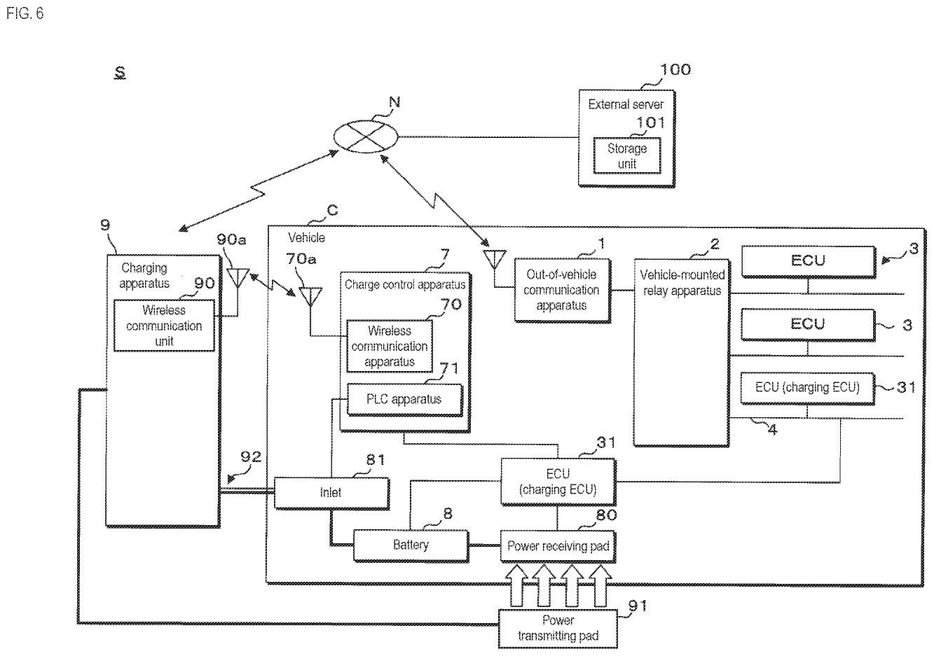

FIG. 6 is a schematic diagram illustrating a configuration of a vehicle-mounted relay system S that includes a vehicle-mounted relay apparatus 2 according to a third embodiment. In FIG. 6, the plurality of charging ECUs 31 are connected to the same communication line 41 (bus).

All of the charging ECUs 31 that are mounted in the vehicle C are connected to the same communication line 41 (bus). Therefore, these charging ECUs 31 are connected to the same in-vehicle communication unit 23 in the vehicle-mounted relay apparatus 2. As a result of all of the charging ECUs 31 that are mounted in the vehicle C being connected to the same communication line 41 (bus), communication between these charging ECUs 31 does not need to be relayed by the vehicle-mounted relay apparatus 2, and a message is transmitted/received between these charging ECUs 31 on the same communication line 41. A mode in which all of the charging ECUs 31 that are mounted in the vehicle C are connected to the same communication line 41 includes a mode in which there are a plurality of charging ECUs 31 and all of the plurality of charging ECUs 31 are connected to the same communication line 41 and a mode in which the number of charging ECUs 31 that are mounted in the vehicle C is one.

In the third embodiment, there is no limitation to the connection form of the charging ECUs 31 shown in FIG. 6, and the connection form of the charging ECU 31 shown in FIG. 1 may be adopted. Accordingly, the vehicle-mounted relay apparatus 2 according to the third embodiment supports two connection forms, namely a mode in which the plurality of charging ECUs 31 are connected to the same communication line 41 (bus) as in FIG. 1 and a mode in which all of the charging ECUs 31 that are mounted in the vehicle C are connected to the same communication line 41 as shown in FIG. 6.

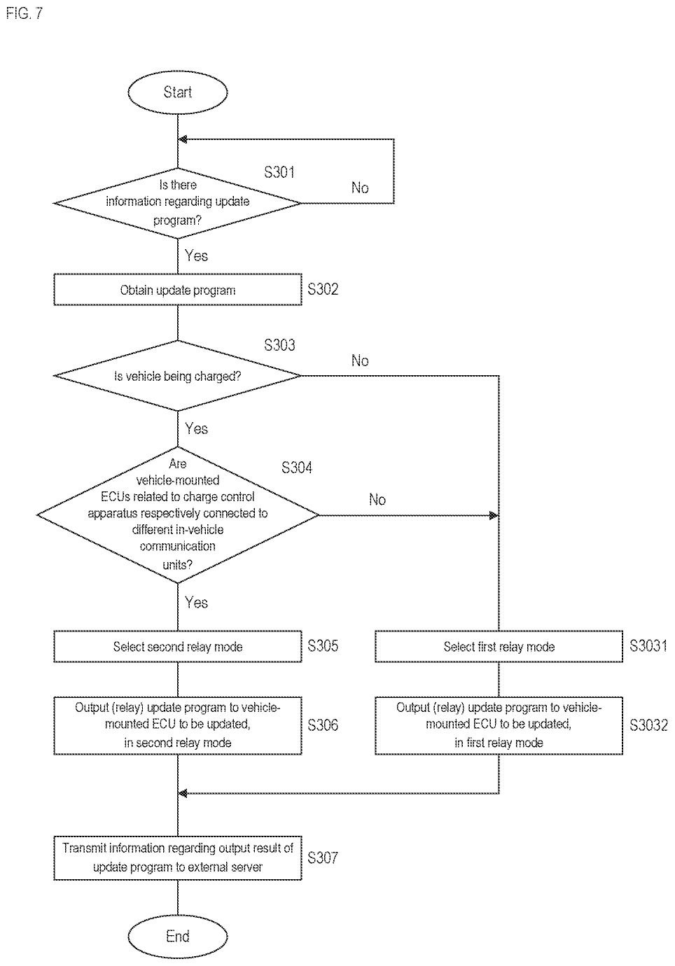

FIG. 7 is a flowchart illustrating processing that is performed by the control unit 20 of the vehicle-mounted relay apparatus 2 according to the third embodiment. When the vehicle C is operating (the IG switch 6 is on) or stopped (the IG switch 6 is off), for example, the control unit 20 of the vehicle-mounted relay apparatus 2 steadily performs the following processing. The control unit 20 of the vehicle-mounted relay apparatus 2 performs the processing of steps S301 to S303 similarly to the processing of steps S101 to S103 in the first embodiment.

When the vehicle C is not being charged (step S303: NO), the control unit 20 of the vehicle-mounted relay apparatus 2 performs the processing of steps S3031 and S3032 similarly to the processing of steps S1031 and S1032 in the first embodiment.

If the vehicle C is being charged (step S303: YES), the control unit 20 of the vehicle-mounted relay apparatus 2 determines whether or not vehicle-mounted ECUs 3 related to the charge control apparatus 7 are respectively connected to different in-vehicle communication units 23 (step S304). The control unit 20 determines whether or not the plurality of charging ECUs 31 are respectively connected to different in-vehicle communication units 23, for example, by referring to the vehicle C configuration information master table or the relay path information (routing table) stored in the storage unit 21 and obtaining the numbers of the connection ports of the charging ECUs 31 for which the function group is “charged”.

If the vehicle-mounted ECUs 3 related to the charge control apparatus 7 are respectively connected to different in-vehicle communication units 23 (step S304: YES), the control unit 20 of the vehicle-mounted relay apparatus 2 selects the second relay mode (step S305). The control unit 20 of the vehicle-mounted relay apparatus 2 performs the processing of steps S305 to S307 similarly to the processing of/in steps S104 to S106 in the first embodiment.

If the vehicle-mounted ECUs 3 related to the charge control apparatus 7 are not respectively connected to different in-vehicle communication units 23 (step S304: NO), the control unit 20 of the vehicle-mounted relay apparatus 2 selects the first relay mode (step S3031). If the charging ECUs 31 are not respectively connected to different in-vehicle communication unit 23, in other words all of the charging ECUs 31 that are mounted in the vehicle C are connected to the same in-vehicle communication unit 23 in the vehicle-mounted relay apparatus 2, and all of these charging ECUs 31 can transmit/receive a message using the same communication line 41 (bus) without the vehicle-mounted relay apparatus 2 needing to perform relay, the control unit 20 selects the first relay mode.

Since all of the charging ECUs 31 that are mounted in the vehicle C are connected to the same communication line 41 (bus), the vehicle-mounted relay apparatus 2 does not need to relay a message that is transmitted/received between the charging ECUs 31. Therefore, by performing the first relay mode in which only an update program is relayed, charging can be continued while suppressing unnecessary relay. As described above, the control unit 20 of the vehicle-mounted relay apparatus 2 performs the processing of steps S3031 and S3032 similarly to the processing of steps S1031 and S1032 in the first embodiment.

According to this embodiment, the vehicle-mounted relay apparatus 2 selects the first relay mode or the second relay mode in accordance with a connection form of charging ECUs 31. The connection form of the charging ECUs 31 described above is determined according to the vehicle type, but by selecting a relay mode in accordance with the connection form of the charging ECUs 31, the vehicle-mounted relay apparatus 2 can be used as a common component that is applied to different vehicle types. That is to say, by mounting the vehicle-mounted relay apparatus 2 according to this embodiment for a vehicle type in which all of the charging ECUs 31 that are mounted in the vehicle C are connected to the same communication line 41 and a vehicle type in which the charging ECUs 31 are respectively connected to different communication lines 41, the vehicle-mounted relay apparatus 2 can support the connection form of the charging ECUs 31 of any vehicle type.

At the time of manufacturing in a factory, even for a vehicle type in which all of the charging ECUs 31 that are mounted in the vehicle C are connected to the same communication line 41, there are cases where the charging ECU 31 are respectively connected to different communication lines 41 as a result of a vehicle-mounted apparatus such as an optional item being additionally implemented after shipment. In this manner, even if the connection form at the time of manufacturing in a factory and the connection form after shipment are different for the same vehicle type, the vehicle-mounted relay apparatus 2 according to this embodiment can select the first relay mode or the second relay mode in accordance with the connection form at the present point in time, and can continue charging along with relay of an update program.

It should be appreciated that the embodiments disclosed herein are to be construed in all respects as illustrative and not limiting. The scope of the present disclosure is defined by the claims, rather than by the description preceding them, and all changes that come within the meaning and range of equivalency of the claims are intended to be embraced therein.

1. A vehicle-mounted relay apparatus that is to be mounted in a vehicle that includes a charge control apparatus, includes a plurality of in-vehicle communication units that are to be connected to a communication line for communicating with a plurality of vehicle-mounted ECUs, and relays, between the in-vehicle communication units, a message that is transmitted from the plurality of vehicle-mounted ECUs, the vehicle-mounted relay apparatus comprising:
a control unit configured to control relay of the message,
wherein the control unit, when relaying an update program obtained from an external server outside the vehicle to a vehicle-mounted ECU to be updated, relays the update program or the message in a plurality of relay modes,
the plurality of relay modes include:
a first relay mode in which relay of a message between vehicle-mounted ECUs other than the vehicle-mounted ECU to be updated is prohibited, and
a second relay mode in which relay of a message between vehicle-mounted ECUs other than the vehicle-mounted ECU to be updated and a vehicle-mounted ECU related to the charge control apparatus is prohibited, and
the control unit selects the first relay mode or the second relay mode based on a predetermined condition.

2. The vehicle-mounted relay apparatus according to claim 1, wherein the predetermined condition includes a condition related to charging of the vehicle, and
the control unit selects the first relay mode when the vehicle is not being charged, and
selects the second relay mode when the vehicle is being charged.

3. The vehicle-mounted relay apparatus according to claim 1, wherein the predetermined condition includes a condition related to a connection form between vehicle-mounted ECUs related to the charge control apparatus and the in-vehicle communication units,
the connection form includes:
a first connection form in which the vehicle-mounted ECUs related to the charge control apparatus are connected to the same in-vehicle communication unit, and
a second connection form in which the vehicle-mounted ECUs related to the charge control apparatus are respectively connected to different in-vehicle communication units, and
the control unit selects the first relay mode when the connection form is the first connection form, and selects the second relay mode when the connection form is the second connection form.

4. The vehicle-mounted relay apparatus according to claim 1, wherein messages that are transmitted from the plurality of vehicle-mounted ECUs include a CAN message that uses a CAN protocol, and
the control unit specifies a message from a vehicle-mounted ECU related to the charge control apparatus based on an identifier included in the CAN message transmitted from the plurality of vehicle-mounted ECUs.

5. The vehicle-mounted relay apparatus according to claim 1, wherein messages that are transmitted from the plurality of vehicle-mounted ECUs include an IP packet that uses an Ethernet protocol, and
the control unit specifies a message from a vehicle-mounted ECU related to the charge control apparatus based on a transmission source address or a transmission destination address included in the IP packet that is transmitted from the plurality of vehicle-mounted ECUs.

6. A program for causing a computer to execute processing for:
obtaining an update program from an external server outside a vehicle;
selecting a first relay mode in which relay of a message between vehicle-mounted ECUs other than a vehicle-mounted ECU to be updated is prohibited or a second relay mode in which relay of a message between vehicle-mounted ECUs other than the vehicle-mounted ECU to be updated and a vehicle-mounted ECU related to a charge control apparatus is prohibited, based on a predetermined condition; and
relaying the update program or a message in the selected relay mode.

7. A relay method for causing a computer to execute processing for:
obtaining an update program from an external server outside a vehicle;
selecting a first relay mode in which relay of a message between vehicle-mounted ECUs other than a vehicle-mounted ECU to be updated is prohibited or a second relay mode in which relay of a message between vehicle-mounted ECUs other than the vehicle-mounted ECU to be updated and a vehicle-mounted ECU related to a charge control apparatus is prohibited, based on a predetermined condition; and
relaying the update program or a message in the selected relay mode.

8. The vehicle-mounted relay apparatus according to claim 2, wherein messages that are transmitted from the plurality of vehicle-mounted ECUs include a CAN message that uses a CAN protocol, and
the control unit specifies a message from a vehicle-mounted ECU related to the charge control apparatus based on an identifier included in the CAN message transmitted from the plurality of vehicle-mounted ECUs.

9. The vehicle-mounted relay apparatus according to claim 3, wherein messages that are transmitted from the plurality of vehicle-mounted ECUs include a CAN message that uses a CAN protocol, and
the control unit specifies a message from a vehicle-mounted ECU related to the charge control apparatus based on an identifier included in the CAN message transmitted from the plurality of vehicle-mounted ECUs.

10. The vehicle-mounted relay apparatus according to claim 2, wherein messages that are transmitted from the plurality of vehicle-mounted ECUs include an IP packet that uses an Ethernet protocol, and
the control unit specifies a message from a vehicle-mounted ECU related to the charge control apparatus based on a transmission source address or a transmission destination address included in the IP packet that is transmitted from the plurality of vehicle-mounted ECUs.

11. The vehicle-mounted relay apparatus according to claim 3, wherein messages that are transmitted from the plurality of vehicle-mounted ECUs include an IP packet that uses an Ethernet protocol, and
the control unit specifies a message from a vehicle-mounted ECU related to the charge control apparatus based on a transmission source address or a transmission destination address included in the IP packet that is transmitted from the plurality of vehicle-mounted ECUs.

12. The vehicle-mounted relay apparatus according to claim 4, wherein messages that are transmitted from the plurality of vehicle-mounted ECUs include an IP packet that uses an Ethernet protocol, and
the control unit specifies a message from a vehicle-mounted ECU related to the charge control apparatus based on a transmission source address or a transmission destination address included in the IP packet that is transmitted from the plurality of vehicle-mounted ECUs.
